(19) United States
(12) Patent Application Publication
(10) Pub. No.: US 2023/0288698 A1
(43) Pub. Date: Sep. 14, 2023

(54) CAMERA MODULE, IMAGING SYSTEM, TRANSPORTATION DEVICE AND LIGHT-EMITTING RECEIVING SYSTEM

(71) Applicant: LARGAN PRECISION CO., LTD., Taichung City (TW)

(72) Inventors: Kuan-Ming CHEN, Taichung City (TW); Yu-Chen LAI, Taichung City (TW)

(21) Appl. No.: 18/165,959

(22) Filed: Feb. 8, 2023

(30) Foreign Application Priority Data
Mar. 14, 2022 (TW) 111202516

(51) Int. Cl. G02B 27/00; G03B 30/00; G02B 27/28; H04N 23/90; B60R 11/04

(52) U.S. Cl. CPC G02B 27/0025; G03B 30/00; G02B 27/283; G02B 27/288; H04N 23/90; B60R 11/04; G02F 1/0136

(57) ABSTRACT

A camera module includes an imaging lens assembly, an image sensor, a plate element and a polarizing element. The imaging lens assembly is configured to define an optical axis. The image sensor is disposed on an image surface of the imaging lens assembly. The plate element is farther from the image sensor than the imaging lens assembly from the image sensor on the optical axis, wherein the plate element is inclined to the optical axis. The polarizing element is disposed on an image side of the plate element, so that an object-side light with a specific polarity from the plate element passes through.

### RELATED APPLICATIONS

This application claims priority to Taiwan Application Serial Number 111202516, filed Mar. 14, 2022, which is herein incorporated by reference.

### BACKGROUND

### Technical Field

The present disclosure relates to a camera module and an imaging system. More particularly, the present disclosure relates to a camera module and an imaging system applicable to a transportation device and a light-emitting receiving system.

### Description of Related Art

In recent years, imaging systems and camera modules thereof are commonly mounted on light-emitting receiving systems and transportation devices, so as to capture the peripheral image for ensuring the traffic safety and the travel safety.

However, the pseudomorphism is easily formed when the plate element of the camera module encounters the strong light, such as the vehicle light of the front vehicle. In detail, when the light passes through the plate element, the multiple reflection of the portion of the light is formed inside the plate element, and the pseudomorphism is easily captured via the imaging system when the plate element is inclined to the optical axis of the imaging lens assembly of the camera module, so that the imaging system is prone to the errors. In severe cases, the safety of the light-emitting receiving system and the transportation device may be influenced. However, the issues of the transportation such as the air resistance and the safety should be concerned, so that the plate element has to be inclined to the optical axis of the imaging lens assembly.

Therefore, a camera module, which can improve the imaging quality, needs to be developed for enhancing the safety of the light-emitting receiving system and the transportation device.

### SUMMARY

According to one aspect of the present disclosure, a camera module includes an imaging lens assembly, an image sensor, a plate element and a polarizing element. The imaging lens assembly is configured to define an optical axis. The image sensor is disposed on an image surface of the imaging lens assembly. The plate element is farther from the image sensor than the imaging lens assembly from the image sensor on the optical axis, wherein the plate element is inclined to the optical axis. The polarizing element is disposed on an image side of the plate element, so that an object-side light with a specific polarity from the plate element passes through. When an angle is between the plate element and the optical axis, the angle is θ, the following condition is satisfied: 5 degrees≤θ<90 degrees.

According to one aspect of the present disclosure, an imaging system includes the camera module of the aforementioned aspect.

According to one aspect of the present disclosure, a transportation device includes the imaging system of the aforementioned aspect.

According to one aspect of the present disclosure, a light-emitting receiving system includes the camera module of the aforementioned aspect and a light-emitting element. The light-emitting element includes a polarizing element, wherein the polarizing element is configured to polarize at least portion of a light emitting from the light-emitting element, and the camera module receives the light from the light-emitting element. A polarizing direction of the polarizing element of the light-emitting element is different from a polarizing direction of the polarizing element of the camera module.

According to one aspect of the present disclosure, a light-emitting receiving system includes a light-emitting element and a camera module. The light-emitting element includes a polarizing element configured to polarize at least portion of a light emitting from the light-emitting element. The camera module is configured to receive the light from the light-emitting element, and includes an imaging lens assembly, an image sensor, a plate element and a polarizing element. The image sensor is disposed on an image surface of the imaging lens assembly. The plate element is farther from the image sensor than the imaging lens assembly from the image sensor on an optical axis. The polarizing element is disposed on an image side of the plate element, so that an object-side light with a specific polarity from the plate element passes through. A polarizing direction of the polarizing element of the light-emitting element is different from a polarizing direction of the polarizing element of the camera module.

### BRIEF DESCRIPTION OF THE DRAWINGS

FIG. 1A is a schematic view of a transportation device and a vehicle lamp of a front vehicle according to the 1st embodiment of the present disclosure.

FIG. 1B is a schematic view of the imaging system according to the 1st example of the 1st embodiment in FIG. 1A.

FIG. 1C is a schematic view of the polarizing element disposed on the transportation device according to the 1st example of the 1st embodiment in FIG. 1A.

FIG. 1D is a schematic view of the transportation device without the polarizing element according to the 1st example of the 1st embodiment in FIG. 1A.

FIG. 1E is a schematic view of the imaging system according to the 2nd example of the 1st embodiment in FIG. 1A.

FIG. 1F is a schematic view of the imaging system according to the 3rd example of the 1st embodiment in FIG. 1A.

FIG. 1G is a schematic view of the imaging system according to the 4th example of the 1st embodiment in FIG. 1A.

FIG. 1H is a schematic view of the imaging system according to the 5th example of the 1st embodiment in FIG. 1A.

FIG. 2A is a schematic view of an imaging system according to the 1st example of the 2nd embodiment of the present disclosure.

FIG. 2B is a schematic view of the polarizing element disposed on the imaging system according to the 1st example of the 2nd embodiment in FIG. 2A.

FIG. 2C is a schematic view of the imaging system without the polarizing element according to the 1st example of the 2nd embodiment in FIG. 2A.

FIG. 2D is a schematic view of a composite image according to the 1st example of the 2nd embodiment in FIG. 2A.

FIG. 2E is a schematic view of the imaging system according to the 2nd example of the 2nd embodiment in FIG. 2A.

FIG. 2F is a schematic view of the imaging system according to the 3rd example of the 2nd embodiment in FIG. 2A.

FIG. 2G is a schematic view of the imaging system according to the 4th example of the 2nd embodiment in FIG. 2A.

FIG. 3A is a schematic view of a light-emitting receiving system according to the 3rd embodiment of the present disclosure.

FIG. 3B is a schematic view of the imaging system according to the 3rd embodiment in FIG. 3A.

FIG. 3C is a schematic view of the polarizing elements disposed on the light-emitting receiving system according to the 3rd embodiment in FIG. 3A.

FIG. 3D is a schematic view of the light-emitting receiving system without the polarizing element according to the 3rd embodiment in FIG. 3A.

FIG. 4A is a schematic view of a transportation device and a wall according to the 4th embodiment of the present disclosure.

FIG. 4B is a schematic view of the light-emitting element according to the 1st example of the 4th embodiment in FIG. 4A.

FIG. 4C is a schematic view of the light-emitting element according to the 2nd example of the 4th embodiment in FIG. 4A.

FIG. 4D is a schematic view of the light-emitting element according to the 3rd example of the 4th embodiment in FIG. 4A.

FIG. 5 is a schematic view of a transportation device according to the 5th embodiment of the present disclosure.

FIG. 6 is a schematic view of a transportation device according to the 6th embodiment of the present disclosure.

FIG. 7 is a schematic view of a transportation device according to the 7th embodiment of the present disclosure.

FIG. 8 is a covering schematic view of a space of a field range of a transportation device according to the 8th embodiment of the present disclosure.

FIG. 9 is a schematic view of a transportation device according to the 9th embodiment of the present disclosure.

FIG. 10 is a schematic view of a transportation device according to the 10th embodiment of the present disclosure.

FIG. 11 is a schematic view of a transportation device according to the 11th embodiment of the present disclosure.

FIG. 12 is a schematic view of a transportation device according to the 12th embodiment of the present disclosure.

### DETAILED DESCRIPTION

The present disclosure provides a camera module, and the camera module includes an imaging lens assembly, an image sensor, a plate element and a polarizing element. The imaging lens assembly is configured to define an optical axis. The image sensor is disposed on an image surface of the imaging lens assembly. The plate element is farther from the image sensor than the imaging lens assembly from the image sensor, wherein the plate element is inclined to the optical axis. The polarizing element is disposed on an image side of the plate element, so that an object-side light with a specific polarity from the plate element passes through. When an angle is between the plate element and the optical axis, and the angle is θ, the following condition is satisfied: 5 degrees≤θ<90 degrees. Further, the following condition can be satisfied: 10 degrees≤θ≤75 degrees. Further, the following condition can be satisfied: 15 degrees≤θ≤50 degrees.

The reflected light formed by the multiple reflections in the plate element can be filtered by disposing the polarizing element between the plate element and the imaging lens assembly. It should be mentioned that the pseudomorphism may be formed via the reflected light under the condition which the polarizing element is not disposed, so as to influence the judgement of the imaging system.

Moreover, the reflection of the object-side light is formed in the plate element, so that the reflected light is polarized, and hence the light path formed by the reflection can be excluded from the aforementioned specific polarity via the polarizing element. Therefore, the pseudomorphism can be avoided.

The imaging lens assembly can include a plurality of lens elements, wherein the lens elements are arranged in order along the optical axis, the lens elements include a first lens element, and the first lens element is one of the lens elements which is closest to the plate element on a direction of the optical axis, and the polarizing element is disposed between the first lens element and the plate element, so that the object-side light with the specific polarity from the plate element passes through the first lens element. Therefore, the unexpected flare formed by the light of pseudomorphism entering the imaging lens assembly can be avoided, so as to enhance the optical quality.

The polarizing element is not parallel to the plate element. Therefore, the function of the polarizing element influenced via the shape of the plate element can be avoided.

The polarizing element can be vertical to the optical axis. Therefore, the controllability of the optical characteristic of the polarizing element can be promoted.

A thickness of the plate element can be between or equal to 1 mm to 50 mm. Therefore, the polarizing element can have the favorable effect. Further, the thickness of the plate element can further be between or equal to 2 mm to 25 mm. Further, the thickness of the plate element can further be between or equal to 3 mm to 13 mm.

The plate element can be a laminated glass, wherein the laminated glass can be an explosive-proof safety glass.

The polarizing element can be a circular polarizer. The reflection of the light with the specific polarity can be avoided forming on the microstructure on the image sensor via the circular polarizer, so as to avoid the imaging quality. In particular, the circular polarizer can include a linear polarizer and a quarter-wave plate.

The camera module can further include an actuator configured to make a polarizing direction of the polarizing element changeable. The condition of the actual pseudomorphism is fine-tuned by changing the polarizing direction of the polarizing element, so as to enhance the effect of eliminating the pseudomorphism. In particular, the aforementioned purpose can be achieved by the mechanical force, such as rotating the polarizing element or changing the stretching direction, or the polarizing direction of the polarizing element can be changed by changing the direction of the electric field and the magnetic field, but the present disclosure is not limited thereto.

The polarizing element can be configured to split a light, so that the object-side light with the specific polarity from the plate element is split up into a first polarizing light and a second polarizing light, and a polarizing direction of the first polarizing light is different from a polarizing direction of the second polarizing light, wherein the polarizing element can be further a polarizing beamsplitter, such as a polarizing beam-splitting prism.

Each of the aforementioned features of the camera module can be utilized in various combinations for achieving the corresponding effects.

The present disclosure provides an imaging system, which includes the aforementioned camera module.

The imaging system can further include another camera module being a second camera module, wherein a visual field of the camera module overlaps a visual field of the second camera module. More imaging information can be obtained via the second camera module, and the quality of the imaging system can be enhanced by the process of image processing, wherein the image processing can be comparison, gain, noise reduction, compositing, AI recognition, but the present disclosure is not limited thereto. For example, the portion of the light is blocked via the polarizing element under the dusky scene, so that the insufficient image information can enter the imaging lens assembly, and hence the recognition of the imaging system under the dusky scene can be enhanced by disposing the second camera module. The spatial location of the object in the visual range can be calculated via the imaging system by the proper disposition, so as to further obtain the three-dimensional image information. Therefore, the accuracy of the imaging system can be enhanced.

The second camera module can include an imaging lens assembly, an image sensor and a polarizing element. The imaging lens assembly includes a plurality of lens elements, wherein the lens elements includes a first lens element, and the first lens element is closer to an object side than other lens elements to the object side. The image sensor is disposed on an image surface of the imaging lens assembly. The polarizing element is disposed between the first lens element and the plate element, so that the object-side light with the specific polarity from the plate element passes through the first lens element. A polarizing direction of the polarizing element of the second camera module is different from a polarizing direction of the polarizing element of the camera module. The pseudomorphism from the different polarizing direction can be eliminated by the polarizing elements from the different polarizing directions, so as to enhance the recognition of the imaging system.

Each of the aforementioned features of the imaging system can be utilized in various combinations for achieving the corresponding effects.

The present disclosure provides a transportation device, which includes the aforementioned imaging system. In particular, the transportation device can be land power devices, water power devices, flying power devices, such as automobiles, motorcycles, power boats, airplanes, drones, but the present disclosure is not limited thereto.

The transportation device can have an inner space, wherein the imaging lens assembly, the image sensor and the polarizing element of the camera module are disposed in the inner space, the camera module receives an object-side light from an outside, and the inner space and the outside are isolated via the plate element. The factors which influence the imaging quality of the imaging lens assembly such as temperature, wind, sun exposure can be reduced by separating the inner space and the outer air, so as to ensure the working stability of the camera module.

The plate element can be a windscreen.

The transportation device can further include a light-emitting element, wherein the light-emitting element includes a polarizing element, and the polarizing element is configured to polarize at least portion of a light emitting from the light-emitting element. A polarizing direction of the polarizing element of the light-emitting element is different from a polarizing direction of the polarizing element of the camera module. Therefore, the camera module can be prevented from receiving the strong light, so as to ensure the completeness of the imaging information.

Each of the aforementioned features of the transportation device can be utilized in various combinations for achieving the corresponding effects.

The present disclosure provides a light-emitting receiving system, which includes a light-emitting element and a camera module. The light-emitting element includes a polarizing element, wherein the polarizing element is configured to polarize at least portion of a light emitting from the light-emitting element. The camera module is configured to receive the light from the light-emitting element, and includes an imaging lens assembly, an image sensor, a plate element and a polarizing element. The image sensor is disposed on an image surface of the imaging lens assembly. The plate element is farther from the image sensor than the imaging lens assembly from the image sensor. The polarizing element is disposed on an image side of the plate element, so that an object-side light with a specific polarity from the plate element passes through. A polarizing direction of the polarizing element of the light-emitting element is different from a polarizing direction of the polarizing element of the camera module. Therefore, the camera module can be prevented from receiving the strong light, so as to ensure the completeness of the imaging information. In particular, the light-emitting receiving system can be urban transportation systems, warehousing systems, unmanned aerial vehicle (UAV) array systems, but the present disclosure is not limited thereto.

According to the aforementioned embodiment, specific embodiments and examples are provided, and illustrated via figures.

### 1st Embodiment

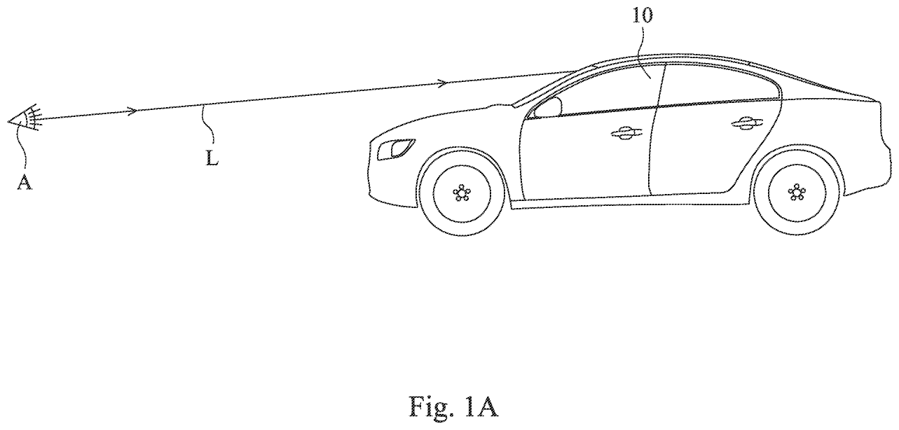

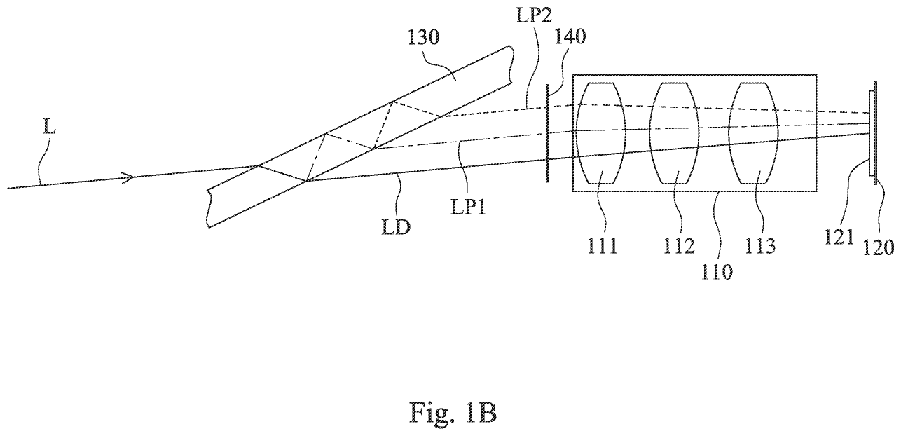

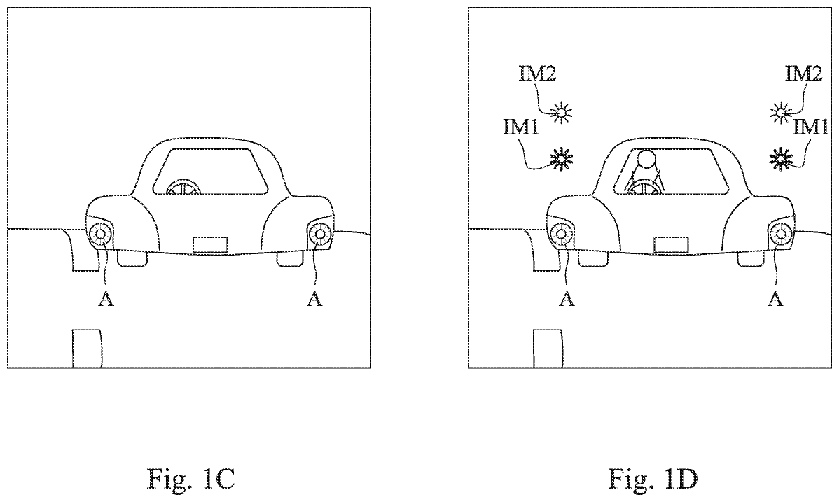

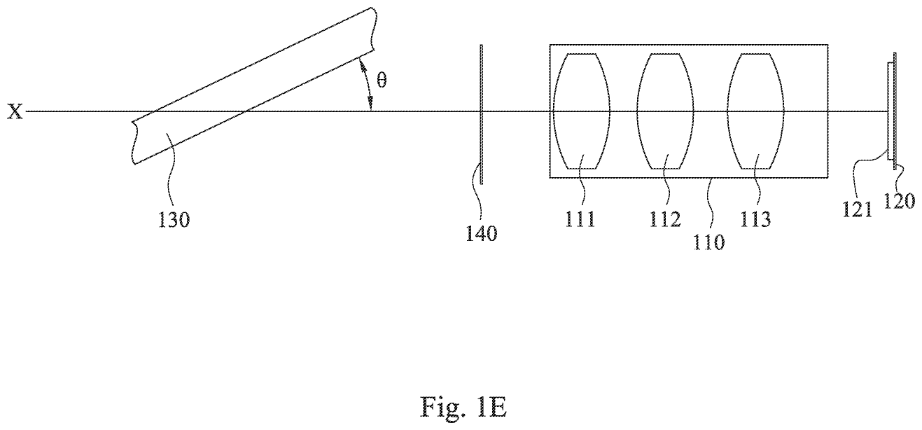

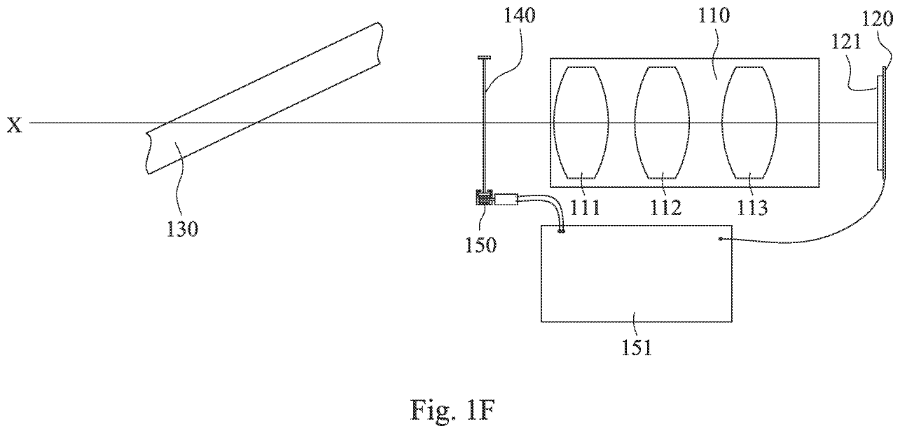

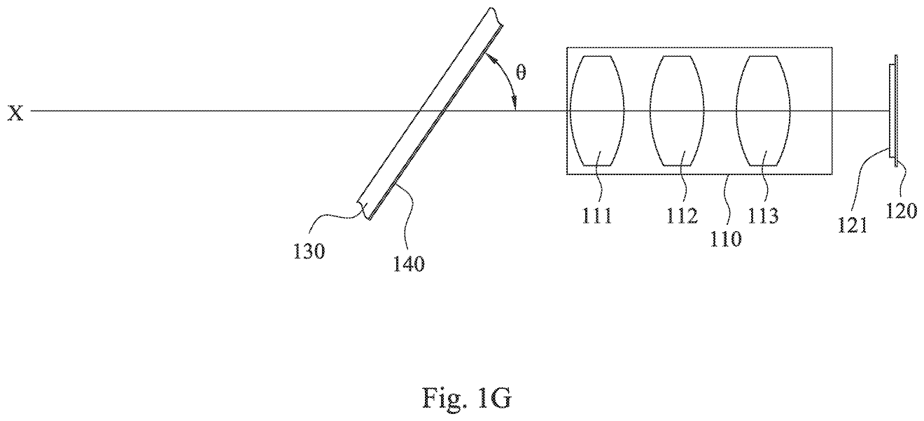

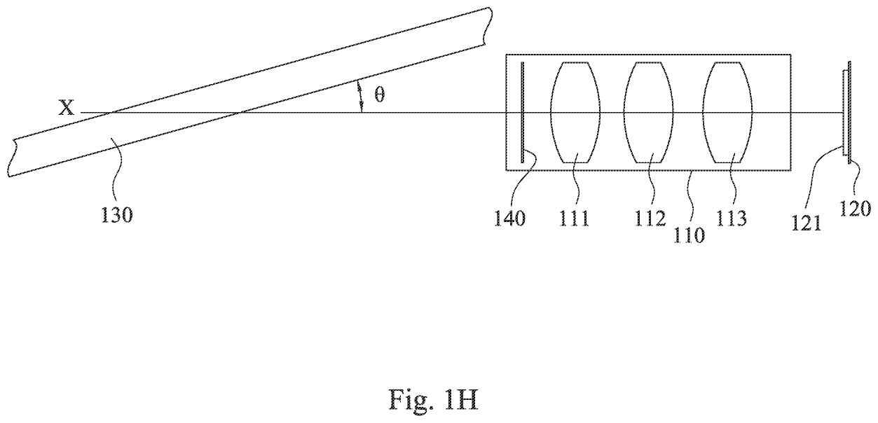

FIG. 1A is a schematic view of a transportation device 10 and a vehicle lamp A of a front vehicle according to the 1st embodiment of the present disclosure. In FIG. 1A, the transportation device 10 includes an imaging system (its reference numeral is omitted), and the imaging system includes a camera module (its reference numeral is omitted), wherein the camera module receives an object-side light L emitting from the vehicle lamp A of the front vehicle. According to the 1st embodiment, the transportation device 10 is an automobile.

FIG. 1B is a schematic view of the imaging system according to the 1st example of the 1st embodiment in FIG. 1A. In FIG. 1B, the camera module includes an imaging lens assembly 110, an image sensor 120, a plate element 130 and a polarizing element 140, wherein the imaging lens assembly 110 is configured to define an optical axis X (labelled in FIG. 1E), the plate element 130 is farther from the image sensor 120 than the imaging lens assembly 110 from the image sensor 120 on the optical axis X, and the plate element 130 is inclined to the optical axis X. Furthermore, the image sensor 120 is disposed on an image surface 121 of the imaging lens assembly 110, and the polarizing element 140 is disposed on an image side of the plate element 130, so that an object-side light with a specific polarity from the plate element 130 passes through.

The reflected light formed by the multiple reflections in the plate element 130 can be filtered by disposing the polarizing element 140 between the plate element 130 and the imaging lens assembly 110. It should be mentioned that the pseudomorphism may be formed via the reflected light under the condition which the polarizing element 140 is not disposed, so as to influence the judgement of the imaging system.

Moreover, the reflection of the object-side light L is formed in the plate element 130, so that the reflected light is polarized, and hence the light path formed by the reflection can be excluded from the aforementioned specific polarity via the polarizing element 140. Therefore, the pseudomorphism can be avoided.

The transportation device 10 has an inner space, wherein the imaging lens assembly 110, the image sensor 120 and the polarizing element 140 of the camera module are disposed in the inner space, wherein the camera module receives an object-side light, which is the object-side light L emitting from the vehicle lamp A of the front vehicle, from an outside, and the inner space and the outside are isolated via the plate element 130. Therefore, the factors which influence the imaging quality of the imaging lens assembly 110 such as temperature, wind, sun exposure can be reduced, so as to ensure the working stability of the camera module. According to the 1st embodiment, the plate element 130 is a windscreen, and can be a laminated glass. Further, the laminated glass can be an explosive-proof safety glass.

The imaging lens assembly 110 includes a plurality of lens elements, wherein the lens elements are arranged in order along the optical axis X, and the lens elements include a first lens element 111 and lens elements 112, 113. In particular, the first lens element 111 is one of the lens elements which is closest to the plate element 130 on a direction of the optical axis X. In other words, the first lens element 111 is closer to the plate element 130 than other lens elements (that is, the lens elements 112, 113) to the plate element 130, and the polarizing element 140 is disposed between the first lens element 111 and the plate element 130, so that the object-side light with the specific polarity from the plate element 130 passes through the first lens element 111. Therefore, the unexpected flare formed by the light of pseudomorphism entering the imaging lens assembly 110 can be avoided, so as to enhance the optical quality.

The polarizing element 140 is not parallel to the plate element 130. Therefore, the function of the polarizing element 140 influenced via the shape of the plate element 130 can be avoided. The polarizing element 140 is vertical to the optical axis X, so as to enhance the controllability of the optical characteristic of the polarizing element 140.

A thickness of the plate element 130 is between or equal to 1 mm to 50 mm. Therefore, the polarizing element 140 can have the favorable effect.

FIG. 1C is a schematic view of the polarizing element 140 disposed on the transportation device 10 according to the 1st example of the 1st embodiment in FIG. 1A. FIG. 1D is a schematic view of the transportation device 10 without the polarizing element according to the 1st example of the 1st embodiment in FIG. 1A. In FIGS. 1B to 1D, when the polarizing element 140 is disposed on the transportation device 10, the light (its reference numeral is omitted) reflected via the plate element 130 passes through a predetermined light path LD (that is, the specific polarity), a light path LP1 (that is, after the secondary reflection) and a light path LP2 (that is, after the quartic reflection) after the camera module receives the object-side light L, then the light passing through the light paths LP1, LP2 via the polarizing element 140 is excluded from entering the imaging lens assembly 110, and only the light passing through the predetermined light path LD images on the image surface 121; when the polarizing element is not disposed on the transportation device 10, the light after reflecting via the plate element 130 passes through the predetermined light path LD, the light path LP1 and the light path LP2 after the camera module receives the object-side light L, then the light enters the imaging lens assembly 110, and all of the light passing the predetermined light path LD and the light paths LP1, LP2 image on the image surface 121, wherein the pseudomorphism IM1 (that is, the light after the secondary reflection) and the pseudomorphism IM2 (that is, the light after the quartic reflection) are formed on the image surface 121.

FIG. 1E is a schematic view of the imaging system according to the 2nd example of the 1st embodiment in FIG. 1A. In FIG. 1E, an angle θ is between the plate element 130 and the optical axis X, and the angle θ is 26 degrees.

FIG. 1F is a schematic view of the imaging system according to the 3rd example of the 1st embodiment in FIG. 1A. In FIG. 1F, the camera module further includes an actuator 150, wherein the actuator 150 is connected to the polarizing element 140, and the actuator 150 is configured to make a polarizing direction of the polarizing element 140 changeable. The condition of the actual pseudomorphism is fine-tuned by changing the polarizing direction of the polarizing element 140, so as to enhance the effect of eliminating the pseudomorphism. In particular, the aforementioned purpose can be achieved by the mechanical force, such as rotating the polarizing element 140 or changing the stretching direction, or the polarizing direction of the polarizing element 140 can be changed by changing the direction of the electric field and the magnetic field, but the present disclosure is not limited thereto.

Further, the actuator 150 is connected to an image processor 151, and the image processor 151 is connected to the image sensor 120. In detail, the object-side light L can come from the different direction, and hence the effect of reducing the pseudomorphism can be enhanced by changing the direction of the polarizing element 140 after the image processor 151 receiving the image signal of the image sensor 120.

FIG. 1G is a schematic view of the imaging system according to the 4th example of the 1st embodiment in FIG. 1A. In FIG. 1G, the polarizing element 140 is disposed on the image-side surface of the plate element 130 to reduce the distance between the plate element 130 and the imaging lens assembly 110, so as to enhance the space utilization.

Moreover, an angle θ is between the plate element 130 and the optical axis X, and the angle θ is 56 degrees.

FIG. 1H is a schematic view of the imaging system according to the 5th example of the 1st embodiment in FIG. 1A. In FIG. 1H, the polarizing element 140 is disposed on the imaging lens assembly 110, so that the imaging lens assembly 110 can be cooperated with the plate element 130 which is more inclined.

Moreover, an angle θ is between the plate element 130 and the optical axis X, and the angle θ is 16 degrees.

### 2nd Embodiment

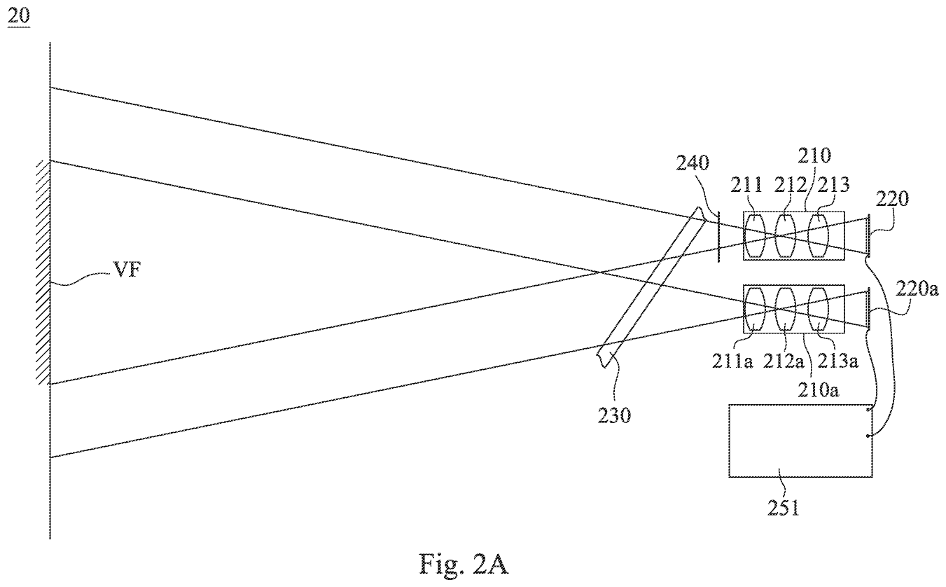

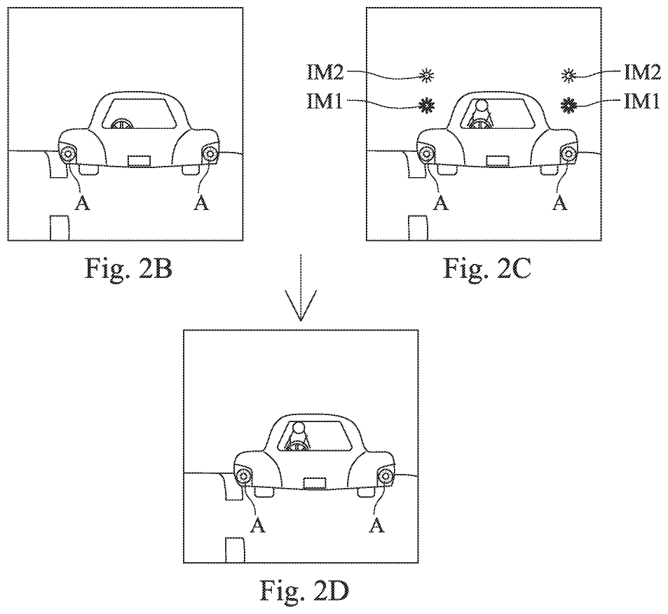

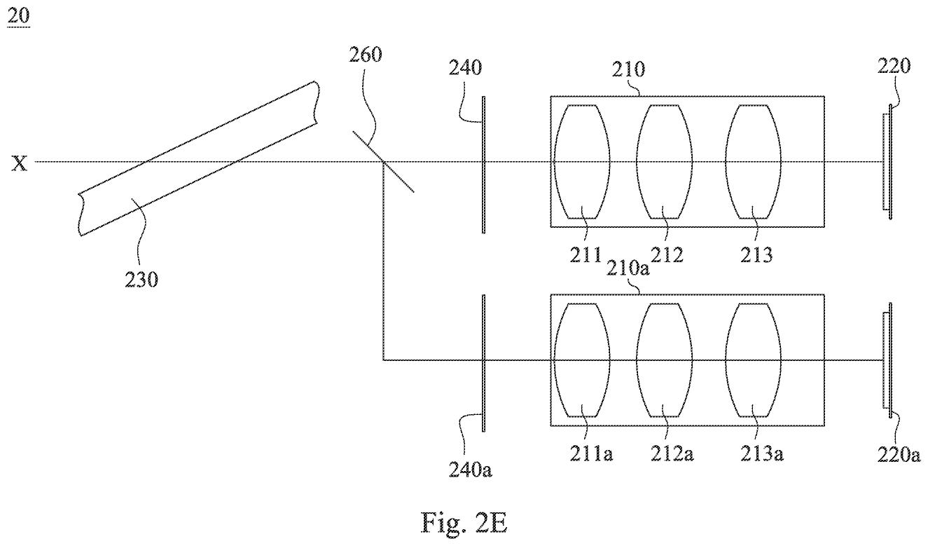

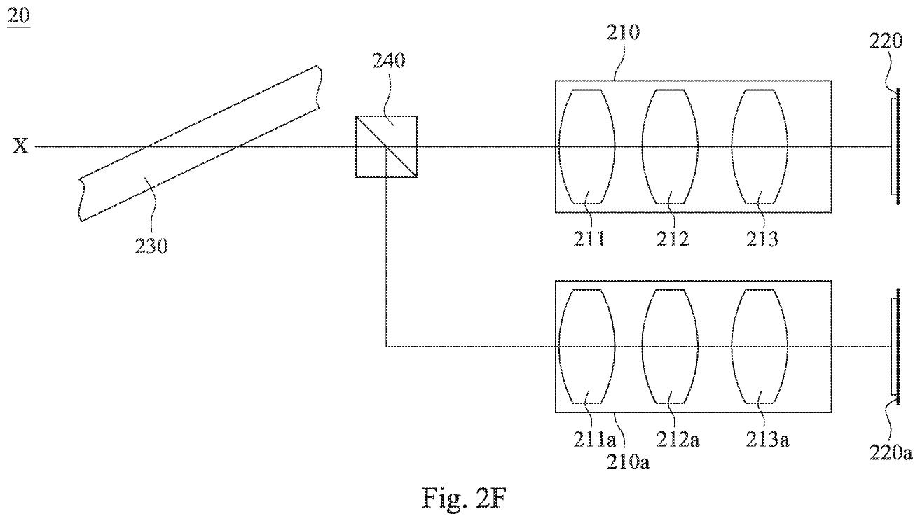

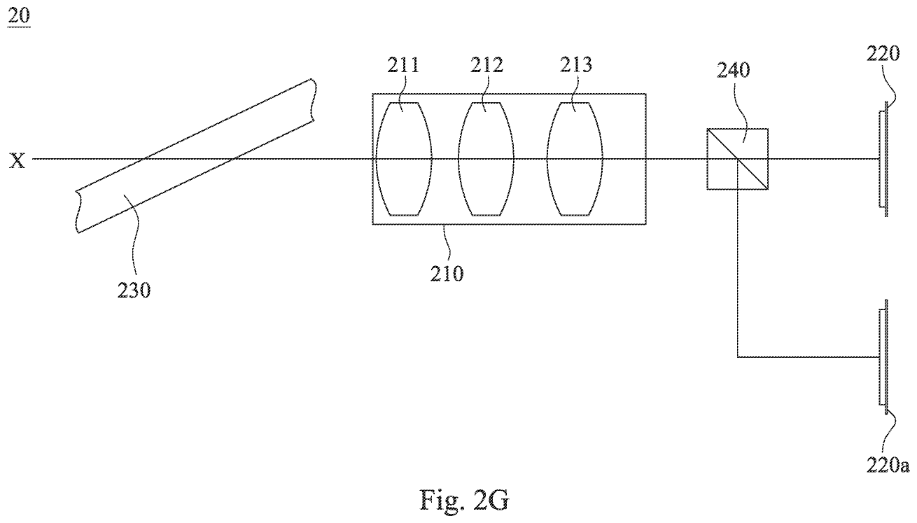

FIG. 2A is a schematic view of an imaging system 20 according to the 1st example of the 2nd embodiment of the present disclosure. In FIG. 2A, the imaging system 20 includes a camera module (its reference numeral is omitted), another camera module (its reference numeral is omitted) and an image processor 251, wherein another camera module is a second camera module, a visual field of the camera module overlaps a visual field of the second camera module, such as the overlapping area VF of the visual field, and the image processor 251 is connected to the camera module and the second camera module.

The camera module includes an imaging lens assembly 210, an image sensor 220, a plate element 230 and a polarizing element 240, wherein the imaging lens assembly 210 is configured to define an optical axis X (labelled in FIG. 2E), the plate element 230 is farther from the image sensor 220 than the imaging lens assembly 210 from the image sensor 220 on the optical axis X, and the plate element 230 is inclined to the optical axis X. Furthermore, the image sensor 220 is disposed on an image surface (its reference numeral is omitted) of the imaging lens assembly 210, and the polarizing element 240 is disposed on an image side of the plate element 230, so that an object-side light (its reference numeral is omitted) with a specific polarity from the plate element 230 passes through. The second camera module includes an imaging lens assembly 210a and an image sensor 220a, wherein the image sensor 220a is disposed on an image surface (its reference numeral is omitted) of the imaging lens assembly 210a.

The imaging lens assembly 210 includes a plurality of lens elements, wherein the lens elements are arranged in order along the optical axis X, and the lens elements include a first lens element 211 and lens elements 212, 213. In particular, the first lens element 211 is one of the lens elements which is closest to the plate element 230 on a direction of the optical axis X. In other words, the first lens element 211 is closer to the plate element 230 than other lens elements (that is, the lens elements 212, 213) to the plate element 230, and the polarizing element 240 is disposed between the first lens element 211 and the plate element 230, so that the object-side light with the specific polarity from the plate element 230 passes through the first lens element 211.

The imaging lens assembly 210a includes a plurality of lens elements, wherein the lens elements include a first lens element 211a and lens elements 212a, 213a, and the first lens element 211a is closer to the object side than other lens elements (that is, the lens elements 212a, 213a) to the object side.

FIG. 2B is a schematic view of the polarizing element 240 disposed on the imaging system 20 according to the 1st example of the 2nd embodiment in FIG. 2A. FIG. 2C is a schematic view of the imaging system 20 without the polarizing element according to the 1st example of the 2nd embodiment in FIG. 2A. FIG. 2D is a schematic view of a composite image according to the 1st example of the 2nd embodiment in FIG. 2A. In FIG. 2B, when the polarizing element 240 is disposed on the imaging system 20, the pseudomorphism is not formed on the image surface after the camera module receiving an object-side light (not shown) emitting from a vehicle lamp A of the front vehicle. However, the portion of the light is blocked via the polarizing element 240 under the dusky scene, so that the insufficient image information can enter the imaging lens assembly 210, that is, the portion of the image may be lost because of the lower brightness. In FIG. 2C, when the polarizing element is not disposed on the imaging system 20, the sufficient brightness can be obtained to provide the complete image information after the second camera module receiving the object-side light emitting from the vehicle lamp A of the front vehicle, but the imaging system is influenced by the pseudomorphisms IM1, IM2. In FIG. 2D, the composite image with the sufficient information and without the influence of the flare can be obtained by comparing and calculating the screen information of the imaging system 20 with the polarizing element 240 and the information of the imaging system 20 without the polarizing element, so as to obtain the composite image without the pseudomorphism and with the sufficient image information. In particular, the recognition of the imaging system 20 under the dusky scene can be enhanced via the second camera module, so as to obtain the more image information, and the quality of the imaging system 20 is enhanced via the image processing, wherein the image processing can be comparison, gain, noise reduction, compositing, AI recognition, but the present disclosure is not limited thereto. Moreover, the spatial location of the object in the visual range can be calculated via the imaging system 20 by the proper disposition, so as to further obtain the three-dimensional image information. Therefore, the accuracy of the imaging system 20 can be enhanced.

FIG. 2E is a schematic view of the imaging system 20 according to the 2nd example of the 2nd embodiment in FIG. 2A. In FIG. 2E, the imaging system 20 further includes a light-splitting element 260, wherein the light-splitting element 260 is disposed between the plate element 230 and the polarizing element 240. The light-splitting element 260 is configured to split the light to the imaging lens assemblies 210, 210a, so as to ensure the overlap of the scene of the camera module and the scene of the second camera module. Further, the light-splitting element 260 can further be a color separation element configured to split the light of the specific wavelength to the specific imaging lens assembly, so as to analyze the light of the different wavelengths. Therefore, the function of the imaging system 20 can be enhanced.

The second camera module further includes a polarizing element 240a, wherein the polarizing element 240a is disposed between the first lens element 211a and the plate element 230, so that the object-side light with the specific polarity from the plate element 230 passes through the first lens element 211a, and a polarizing direction of the polarizing element 240a is different from a polarizing direction of the polarizing element 240. The pseudomorphism from the different polarizing directions can be eliminated by the polarizing elements from the different polarizing directions, so as to enhance the recognition of the imaging system 20.

FIG. 2F is a schematic view of the imaging system 20 according to the 3rd example of the 2nd embodiment in FIG. 2A. In FIG. 2F, the polarizing element 240 is configured to split the light, so that the object-side light with the specific polarity from the plate element 230 is split up into a first polarizing light and a second polarizing light, and a polarizing direction of the first polarizing light is different from a polarizing direction of the second polarizing light, wherein the polarizing element 240 can be further a polarizing beamsplitter, such as a polarizing beam-splitting prism.

In particular, the function of polarizing the light and the function of splitting the light can be simultaneously obtained via the polarizing element 240, the polarizing element 240 is configured to split the light with the specific polarity to the second camera module, and the rest of the light is received via the camera module, so that the number of the optical elements can be reduced.

FIG. 2G is a schematic view of the imaging system 20 according to the 4th example of the 2nd embodiment in FIG. 2A. In FIG. 2G, the polarizing element 240 is configured to split a light, so that the object-side light with the specific polarity from the plate element 230 is split up into a first polarizing light and a second polarizing light, and a polarizing direction of the first polarizing light is different from a polarizing direction of the second polarizing light.

In particular, the function of polarizing the light and the function of splitting the light can be simultaneously obtained via the polarizing element 240, and the polarizing element 240 is disposed on the image side of the imaging lens assembly 210, so that the polarizing element 240 is configured to split the light with the specific polarity which passes through the imaging lens assembly 210 to the image sensors 220, 220a, so as to simultaneously obtain the image information with different polarizing direction.

Further, all of other structures and dispositions according to the 2nd embodiment are the same as the structures and the dispositions according to the 1st embodiment, and will not be described again herein.

### 3rd Embodiment

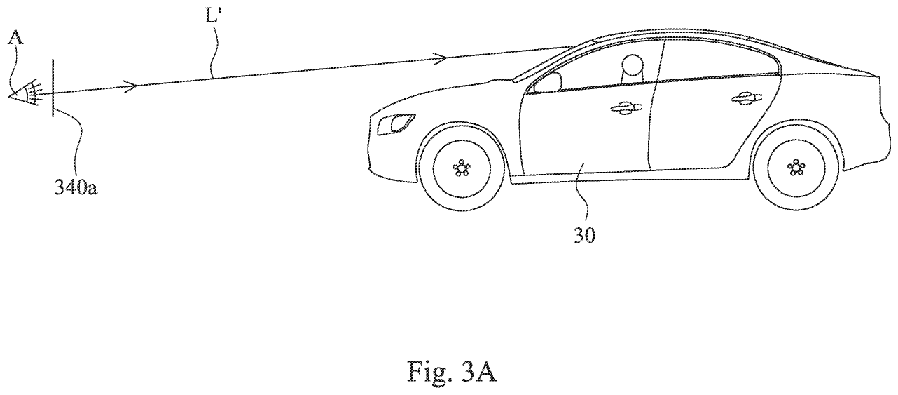

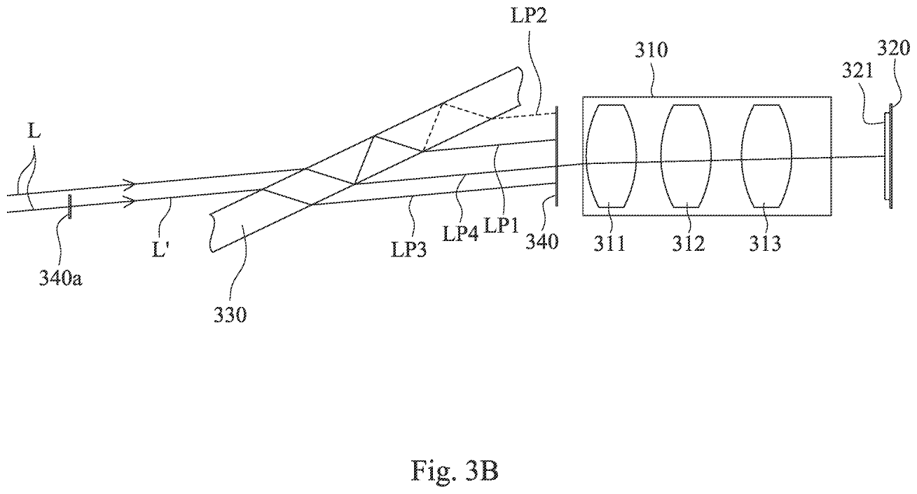

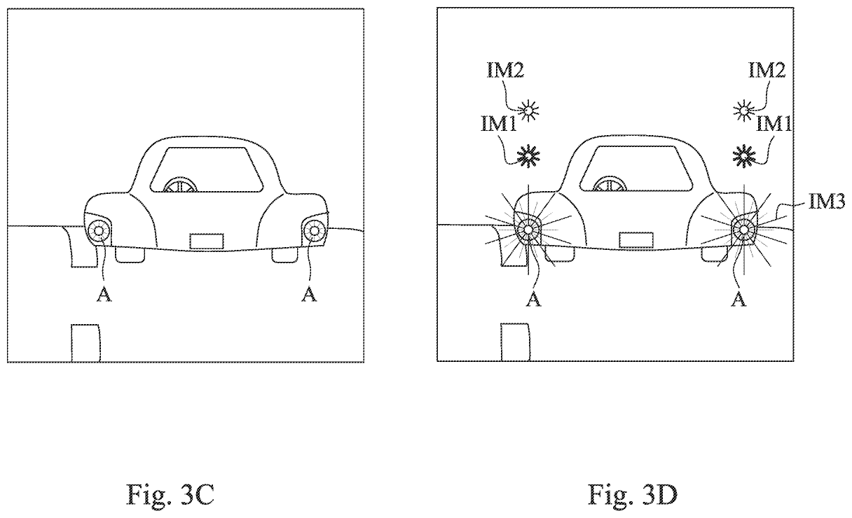

FIG. 3A is a schematic view of a light-emitting receiving system according to the 3rd embodiment of the present disclosure. In FIG. 3A, the light-emitting receiving system (its reference numeral is omitted) includes a transportation device 30 and a light-emitting element (its reference numeral is omitted), wherein the transportation device 30 includes an imaging system (its reference numeral is omitted). The imaging system includes a camera module (its reference numeral is omitted), wherein the camera module receives an object-side light L (labelled in FIG. 3B) emitting from the vehicle lamp A of the front vehicle. According to the 3rd embodiment, the light-emitting receiving system is an urban transportation system, the transportation device 30 is an automobile, and the light-emitting element is the vehicle lamp A of the front vehicle.

FIG. 3B is a schematic view of the imaging system according to the 3rd embodiment in FIG. 3A. In FIG. 3B, the camera module includes an imaging lens assembly 310, an image sensor 320, a plate element 330 and a polarizing element 340, wherein the imaging lens assembly 310 is configured to define an optical axis (its reference numeral is omitted), the plate element 330 is farther from the image sensor 320 than the imaging lens assembly 310 from the image sensor 320 on the optical axis, and the plate element 330 is inclined to the optical axis. Furthermore, the image sensor 320 is disposed on an image surface 321 of the imaging lens assembly 310, and the polarizing element 340 is disposed on an image side of the plate element 330, so that an object-side light with a specific polarity from the plate element 330 passes through.

The imaging lens assembly 310 includes a plurality of lens elements, wherein the lens elements are arranged in order along the optical axis, and the lens elements include a first lens element 311 and lens elements 312, 313. In particular, the first lens element 311 is one of the lens elements which is closest to the plate element 330 on a direction of the optical axis, that is the first lens element 311 is closer to the plate element 330 than other lens elements (that is, the lens elements 312, 313) to the plate element 330, and the polarizing element 340 is disposed between the first lens element 311 and the plate element 330, so that the object-side light with the specific polarity from the plate element 330 passes through the first lens element 311.

The light-emitting element includes a polarizing element 340a, and the polarizing element 340a is configured to polarize at least portion of a light emitting from the light-emitting element, that is the object-side light L emitting from the vehicle lamp A of the front vehicle, and the camera module is configured to receive the light from the light-emitting element. In particular, a polarizing direction of the polarizing element 340a of the light-emitting element is different from a polarizing direction of the polarizing element 340 of the camera module. Therefore, the camera module can be prevented from receiving the strong light, so as to ensure the completeness of the imaging information.

FIG. 3C is a schematic view of the polarizing elements 340, 340a disposed on the light-emitting receiving system according to the 3rd embodiment in FIG. 3A. FIG. 3D is a schematic view of the light-emitting receiving system without the polarizing element according to the 3rd embodiment in FIG. 3A. In FIGS. 3B to 3D, when the polarizing elements 340, 340a are disposed on the light-emitting receiving system, the light (its reference numeral is omitted) reflected via the plate element 330 passes through a light path LP1 (that is, after the secondary reflection), a light path LP2 (that is, after the quartic reflection) and a light path LP4 (that is, the light path of the light without the polarity) after the camera module receives the object-side light L, and the camera module receives a light L′ passing through the polarizing element 340a, then the light reflected via the plate element 330 passes through the light path LP3 (that is, the light path of the light with the polarity), wherein only the light passing through the light path LP4 images on the image surface 321; when the polarizing element is not disposed on the light-emitting receiving system, the light reflected via the plate element 330 passes the light paths LP1, LP2, LP4 after the camera module receives the object-side light L, then the light enters the imaging lens assembly 310, and all of the light passing the light paths LP1, LP2, LP4 image on the image surface 321, wherein the pseudomorphism IM1 (that is, the light after the secondary reflection), the pseudomorphism IM2 (that is, the light after the quartic reflection) and the flare IM3 are formed on the image surface 321.

In FIG. 3C, the portion of the light (that is, the light L′) has the polarity by disposing the polarizing element 340a which the polarizing direction is different from the polarizing direction of the polarizing element 340, and the portion of the light is excluded from the object-side light of the specific polarity during passing through the polarizing element 340. Therefore, the image sensor 320 can be prevented from receiving the strong light, wherein the polarizing element 340a can be a circular polarizer.

In FIG. 3D, under the condition that the polarizing element is not disposed on the light-emitting receiving system, different from the observation via the human eyes, the scene that the strong light source and the weak light source simultaneously exist cannot be simultaneously treated because of the limitation of the image sensor 320. Hence, when the brightness of the vehicle lamp A is too bright, the peripheral area of the vehicle lamp A is excessively exposed, and the area exclusive of the vehicle lamp A is underexposed, so that the scene is lack of the information.

Further, all of other structures and dispositions according to the 3rd embodiment are the same as the structures and the dispositions according to the 1st embodiment, and will not be described again herein.

### 4th Embodiment

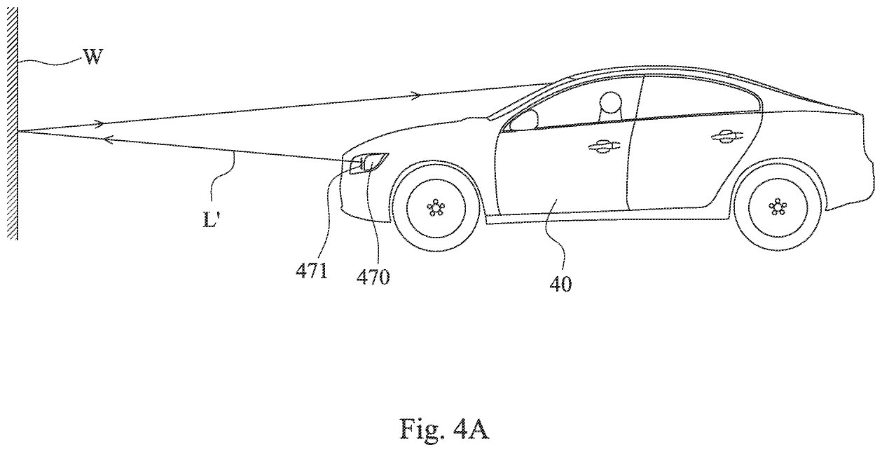

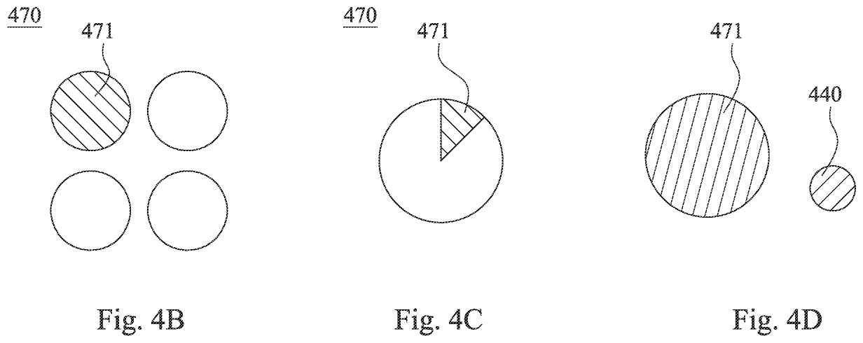

FIG. 4A is a schematic view of a transportation device 40 and a wall W according to the 4th embodiment of the present disclosure. In FIG. 4A, the transportation device 40 includes a camera module (not shown) and a light-emitting element 470, wherein the light-emitting element 470 includes a polarizing element 471, the polarizing element 471 is configured to polarize at least portion of a light L′ emitting from the light-emitting element 470, and the camera module is configured to receive the light L′ from the light-emitting element 470, wherein the light L′ is reflected via the wall W and then the light L′ is received via the camera module, but the present disclosure is not limited thereto. The camera module includes an imaging lens assembly (not shown), an image sensor (not shown), a plate element (its reference numeral is omitted) and a polarizing element 440 (labelled in FIG. 4D), wherein the image sensor is disposed on an image surface (not shown) of the imaging lens assembly, the plate element is farther from the image sensor than the imaging lens assembly from the image sensor on the optical axis, and the polarizing element 440 is disposed on an image side of the plate element, so that an object-side light (not shown) with a specific polarity from the plate element passes through. In particular, a polarizing direction of the polarizing element 471 of the light-emitting element 470 is different from a polarizing direction of the polarizing element 440 of the camera module. Therefore, the camera module can be prevented from receiving the strong light, so as to ensure the completeness of the imaging information. According to the 4th embodiment, the transportation device 40 is an automobile, and the light-emitting element 470 is a vehicle lamp of the vehicle.

Moreover, the polarizing element 471 is a circular polarizer. Therefore, the reflection of the light with the specific polarity can be avoided forming on the microstructure on the image sensor via the circular polarizer, so as to avoid the imaging quality.

FIG. 4B is a schematic view of the light-emitting element 470 according to the 1st example of the 4th embodiment in FIG. 4A. In FIG. 4B, when the light-emitting element 470 includes a plurality of light sources (their reference numerals are omitted), the polarizing element 471 can be selectively disposed on at least one of the light sources, so as to control the brightness of the light L′ entering the camera module. According to the 1st example of the 4th embodiment, the polarizing element 471 is disposed on 25% of the aperture area.

FIG. 4C is a schematic view of the light-emitting element 470 according to the 2nd example of the 4th embodiment in FIG. 4A. In FIG. 4C, the polarizing element 471 is disposed on the partial area of the light-emitting element 470, so as to control the brightness of the light L′ entering the camera module. According to the 2nd example of the 4th embodiment, the polarizing element 471 is disposed on 12.5% of the aperture area.

FIG. 4D is a schematic view of the light-emitting element 470 according to the 3rd example of the 4th embodiment in FIG. 4A. In FIG. 4D, when the polarizing element 471 is disposed on the light-emitting element 470, the polarizing direction of the polarizing element 471 is non-orthogonal to the polarizing direction of the polarizing element 440 by adjusting the polarizing direction thereof. That is, the portion of the light can pass through the polarizing element 440, so as to control the brightness of the light entering the camera module. According to the 3rd example of the 4th embodiment, the polarizing element 471 is disposed on all of the aperture area.

Further, all of other structures and dispositions according to the 4th embodiment are the same as the structures and the dispositions according to the 1st embodiment, and will not be described again herein.

### 5th Embodiment

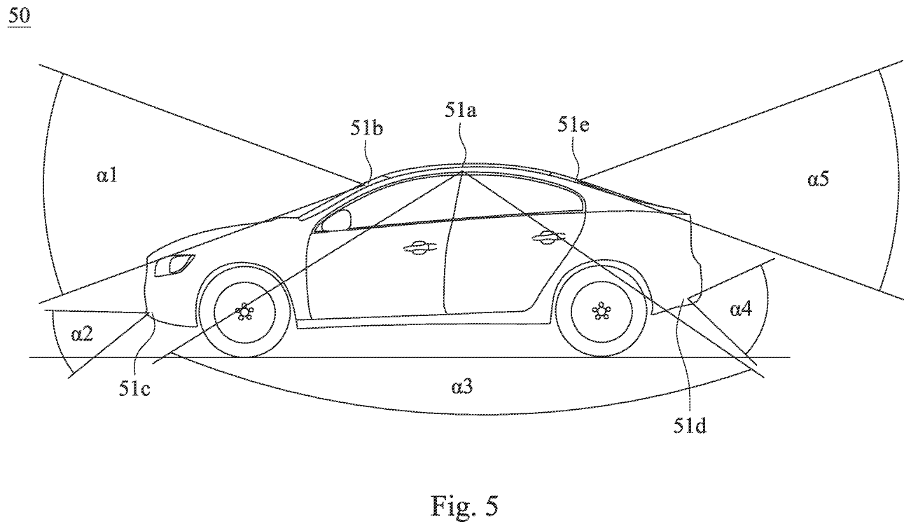

FIG. 5 is a schematic view of a transportation device 50 according to the 5th embodiment of the present disclosure. In FIG. 5, the transportation device 50 includes an imaging system (its reference numeral is omitted), wherein the imaging system includes a plurality of camera modules 51a, 51b, 51c, 51d, 51e. According to the 5th embodiment, the transportation device 50 is an automobile.

In particular, the camera module 51a is disposed on a side of the transportation device 50, the camera module 51b is disposed on a windscreen of the transportation device 50, the camera module 51c is disposed on a front end of the transportation device 50, the camera module 51d is disposed on a rear end of the transportation device 50, and the camera module 51e is disposed on a rear window of the transportation device 50. Therefore, the imaging information of visual fields α1, α2, α3, α4, α5 can be captured via the transportation device 50.

Moreover, the camera module can be one of the camera modules according to the aforementioned 1st embodiment to the 4th embodiment, but the present disclosure is not limited thereto.

Further, all of other structures and dispositions according to the 5th embodiment are the same as the structures and the dispositions according to the 1st embodiment, and will not be described again herein.

### 6th Embodiment

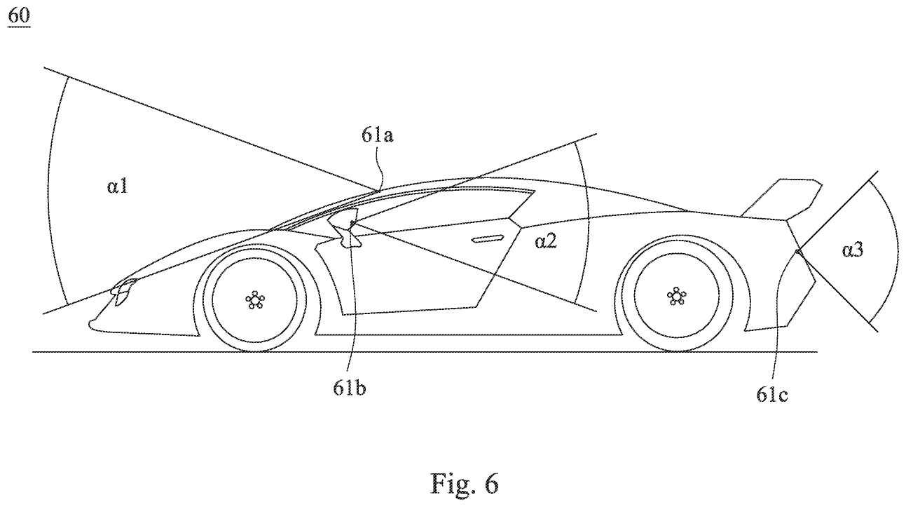

FIG. 6 is a schematic view of a transportation device 60 according to the 6th embodiment of the present disclosure. In FIG. 6, the transportation device 60 includes an imaging system (its reference numeral is omitted), wherein the imaging system includes a plurality of camera modules 61a, 61b, 61c. According to the 6th embodiment, the transportation device 60 is an automobile.

In particular, the camera module 61a is disposed on a windscreen of the transportation device 60, the camera module 61b is disposed below a rear-view mirror of the transportation device 60, and the camera module 61c is disposed on a rear end of the transportation device 60. Therefore, the imaging information of visual fields α1, α2, α3 can be captured via the transportation device 60.

Moreover, the camera module can be one of the camera modules according to the aforementioned 1st embodiment to the 4th embodiment, but the present disclosure is not limited thereto.

Further, all of other structures and dispositions according to the 6th embodiment are the same as the structures and the dispositions according to the 1st embodiment, and will not be described again herein.

### 7th Embodiment

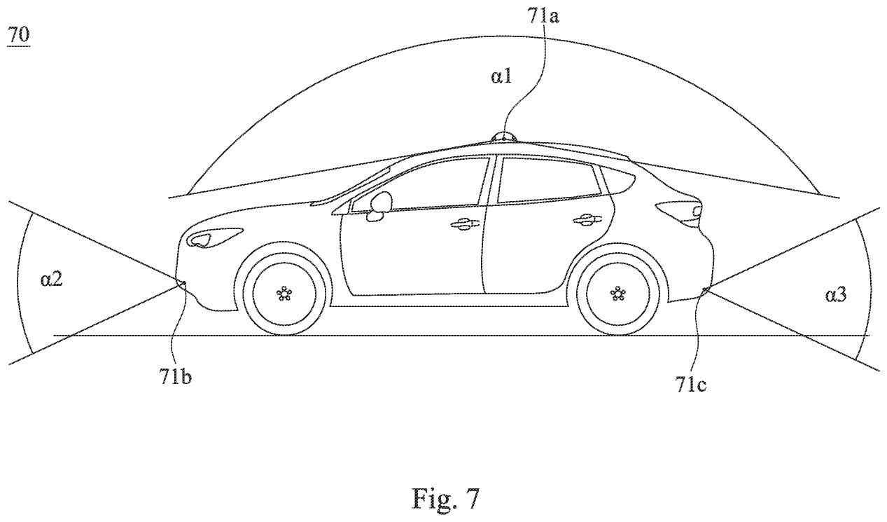

FIG. 7 is a schematic view of a transportation device 70 according to the 7th embodiment of the present disclosure. In FIG. 7, the transportation device 70 includes an imaging system (its reference numeral is omitted), wherein the imaging system includes a plurality of camera modules 71a, 71b, 71c. According to the 7th embodiment, the transportation device 70 is an automobile.

In particular, the camera module 71a is disposed on a top of the transportation device 70, the camera module 71b is disposed on a front end of the transportation device 70, and the camera module 71c is disposed on a rear end of the transportation device 70, wherein the camera module 71a is a surround view camera module. Therefore, the imaging information of visual fields α1, α2, α3 can be captured via the transportation device 70.

Moreover, the camera module can be one of the camera modules according to the aforementioned 1st embodiment to the 4th embodiment, but the present disclosure is not limited thereto.

Further, all of other structures and dispositions according to the 7th embodiment are the same as the structures and the dispositions according to the 1st embodiment, and will not be described again herein.

### 8th Embodiment

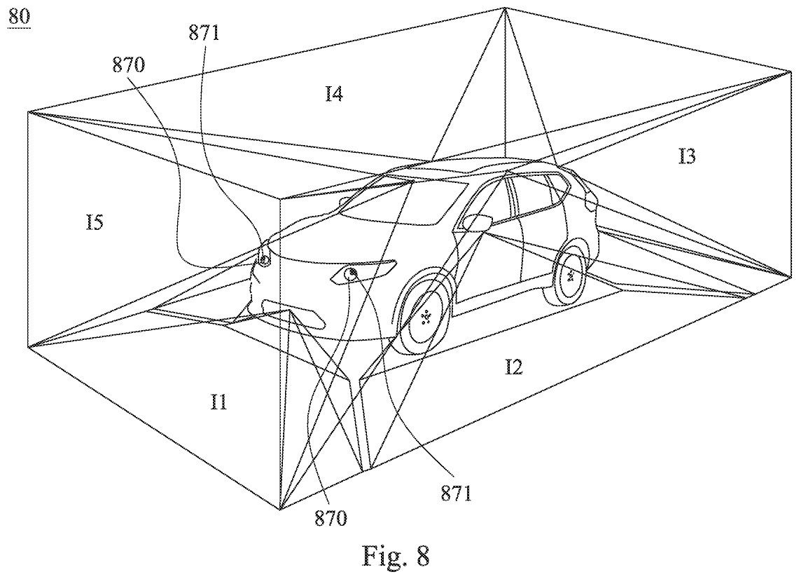

FIG. 8 is a covering schematic view of a space of a field range of a transportation device 80 according to the 8th embodiment of the present disclosure. In FIG. 8, the transportation device 80 includes an imaging system (its reference numeral is omitted), wherein the imaging system includes a plurality of camera modules (their reference numerals are omitted). According to the 8th embodiment, the transportation device 80 is an automobile.

In particular, the camera modules can be disposed on a front end, a rear end, below a left rear-view mirror and a right rear-view mirror, on a windscreen and a side of the transportation device 80, respectively, so as to make for the drivers to obtain external space informations in addition to the transportation device 80, such as external space informations 11, 12, 13, 14, 15, but the present disclosure is not limited thereto. Therefore, more visual angles can be provided to reduce the blind spot, so that the driving safety can be improved.

Moreover, the camera module can be one of the camera modules according to the aforementioned 1st embodiment to the 4th embodiment, but the present disclosure is not limited thereto.

Furthermore, the transportation device 80 further includes a light-emitting element 870, wherein the light-emitting element 870 includes a polarizing element 871, and the polarizing element 871 is disposed on the partial area of the light-emitting element 870. According to the 8th embodiment, the light-emitting element 870 is a vehicle lamp.

Further, all of other structures and dispositions according to the 8th embodiment are the same as the structures and the dispositions according to the 1st embodiment and the 4th embodiment, and will not be described again herein.

### 9th Embodiment

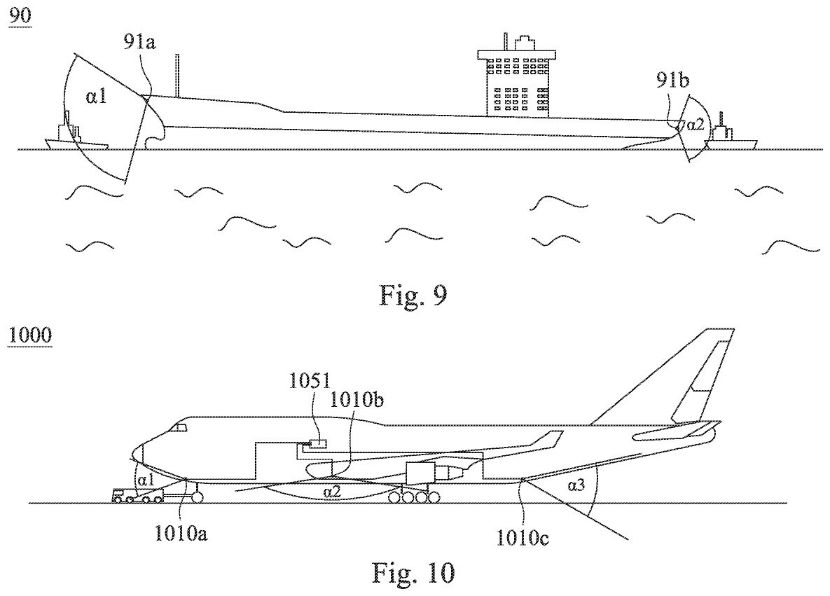

FIG. 9 is a schematic view of a transportation device 90 according to the 9th embodiment of the present disclosure. In FIG. 9, the transportation device 90 includes an imaging system (its reference numeral is omitted), wherein the imaging system includes a plurality of camera modules 91a, 91b. According to the 9th embodiment, the transportation device 90 is a power boat.

In particular, the camera module 91a is disposed on a front end of the transportation device 90, and the camera module 91b is disposed on a rear end of the transportation device 90. Therefore, the imaging information of visual fields α1, α2 can be captured via the transportation device 90.

Moreover, the camera module can be one of the camera modules according to the aforementioned 1st embodiment to the 4th embodiment, but the present disclosure is not limited thereto.

Further, all of other structures and dispositions according to the 9th embodiment are the same as the structures and the dispositions according to the 1st embodiment, and will not be described again herein.

### 10th Embodiment

FIG. 10 is a schematic view of a transportation device 1000 according to the 10th embodiment of the present disclosure. In FIG. 10, the transportation device 1000 includes an imaging system (its reference numeral is omitted), wherein the imaging system includes a plurality of camera modules 1010a, 1010b, 1010c and an image processor 1051, and the image processor 1051 is connected to the camera modules 1010a, 1010b, 1010c. According to the 10th embodiment, the transportation device 1000 is an airplane.

In particular, the camera module 1010a is disposed on a front end of the transportation device 1000, the camera module 1010b is disposed below the transportation device 1000, and the camera module 1010c is disposed on a rear end of the transportation device 1000. Therefore, the imaging information of visual fields α1, α2, α3 can be captured via the transportation device 1000.

Moreover, the camera module can be one of the camera modules according to the aforementioned 1st embodiment to the 4th embodiment, but the present disclosure is not limited thereto.

Further, all of other structures and dispositions according to the 10th embodiment are the same as the structures and the dispositions according to the 1st embodiment, and will not be described again herein.

### 11th Embodiment

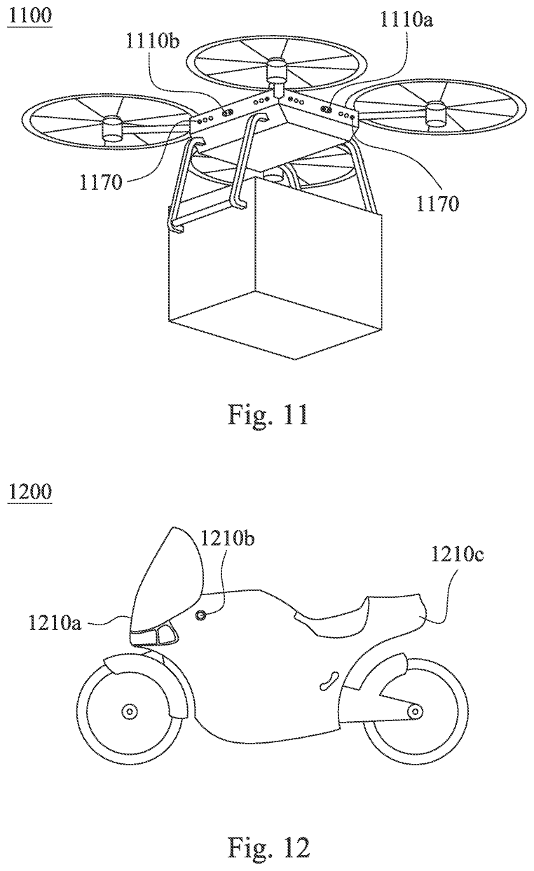

FIG. 11 is a schematic view of a transportation device 1100 according to the 11th embodiment of the present disclosure. In FIG. 11, the transportation device 1100 includes an imaging system (its reference numeral is omitted), wherein the imaging system includes a plurality of camera modules 1110a, 1110b. According to the 11th embodiment, the transportation device 1100 is a drone.

In particular, the camera module 1110a is disposed on a front end of the transportation device 1100, and the camera module 1110b is disposed on a side of the transportation device 1100. It should be mentioned that a number of each of the camera modules 1110a, 1110b is two, wherein the camera modules 1110a have the overlapping area of the visual field, and the camera modules 1110b have the overlapping area of the visual field. Therefore, the complicated ambient light can be conquered via the transportation device 1100.

Moreover, the camera module can be one of the camera modules according to the aforementioned 1st embodiment to the 4th embodiment, but the present disclosure is not limited thereto.

The transportation device 1100 further includes a light-emitting element 1170, wherein the light-emitting element 1170 includes a plurality of light sources (their reference numerals are omitted) and a polarizing element (its reference numeral is omitted), and the polarizing element is selectively disposed on at least one of the light sources, so that the light with the polarity is emitted via the partial light sources.

Further, all of other structures and dispositions according to the 11th embodiment are the same as the structures and the dispositions according to the 1st embodiment and the 4th embodiment, and will not be described again herein.

### 12th Embodiment

FIG. 12 is a schematic view of a transportation device 1200 according to the 12th embodiment of the present disclosure. In FIG. 12, the transportation device 1200 includes an imaging system (its reference numeral is omitted), wherein the imaging system includes a plurality of camera modules 1210a, 1210b, 1210c. According to the 12th embodiment, the transportation device 1200 is a motorcycle.

In particular, the camera module 1210a is disposed on a front end of the transportation device 1200, the camera module 1210b is disposed on a side of the transportation device 1200, and the camera module 1210c is disposed on a rear end of the transportation device 1200. Therefore, the imaging information around the transportation device 1200 can be captured via the transportation device 1200.

Moreover, the camera module can be one of the camera modules according to the aforementioned 1st embodiment to the 4th embodiment, but the present disclosure is not limited thereto.

Further, all of other structures and dispositions according to the 12th embodiment are the same as the structures and the dispositions according to the 1st embodiment, and will not be described again herein.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. A camera module, comprising:
an imaging lens assembly configured to define an optical axis;
an image sensor disposed on an image surface of the imaging lens assembly;
a plate element farther from the image sensor than the imaging lens assembly from the image sensor on the optical axis, wherein the plate element is inclined to the optical axis; and
a polarizing element disposed on an image side of the plate element, so that an object-side light with a specific polarity from the plate element passing through;
wherein an angle is between the plate element and the optical axis, the angle is θ, and the following condition is satisfied:
5 degrees≤θ<90 degrees.

2. The camera module of claim 1, wherein the imaging lens assembly comprises a plurality of lens elements, the lens elements are arranged in order along the optical axis, the lens elements comprise a first lens element, the first lens element is one of the lens elements which is closest to the plate element on a direction of the optical axis, and the polarizing element is disposed between the first lens element and the plate element, so that the object-side light with the specific polarity from the plate element passes through the first lens element.

3. The camera module of claim 1, wherein the polarizing element is not parallel to the plate element.

4. The camera module of claim 1, wherein the polarizing element is vertical to the optical axis.

5. The camera module of claim 1, wherein a thickness of the plate element is between or equal to 1 mm to 50 mm.

6. The camera module of claim 1, wherein the plate element is a laminated glass.

7. The camera module of claim 1, wherein the polarizing element is a circular polarizer.

8. The camera module of claim 1, further comprising:
an actuator configured to make a polarizing direction of the polarizing element changeable.

9. The camera module of claim 1, wherein the polarizing element is configured to split a light, so that the object-side light with the specific polarity from the plate element is split up into a first polarizing light and a second polarizing light, and a polarizing direction of the first polarizing light is different from a polarizing direction of the second polarizing light.

10. An imaging system, comprising:
the camera module of claim 1.

11. The imaging system of claim 10, further comprising:
another camera module being a second camera module, wherein a visual field of the camera module overlaps a visual field of the second camera module.

12. The imaging system of claim 11, wherein the second camera module comprises:
an imaging lens assembly comprising a plurality of lens elements, the lens elements comprising a first lens element, and the first lens element closer to an object side than other lens elements to the object side;
an image sensor disposed on an image surface of the imaging lens assembly; and
a polarizing element disposed between the first lens element and the plate element, so that the object-side light with the specific polarity from the plate element passing through the first lens element;
wherein a polarizing direction of the polarizing element of the second camera module is different from a polarizing direction of the polarizing element of the camera module.

13. A transportation device, comprising:
the imaging system of claim 10.

14. The transportation device of claim 13, wherein the transportation device has an inner space, the imaging lens assembly, the image sensor and the polarizing element of the camera module are disposed in the inner space;
wherein the camera module receives an object-side light from an outside, and the inner space and the outside are isolated via the plate element.

15. The transportation device of claim 13, wherein the plate element is a windscreen.

16. The transportation device of claim 13, further comprising:
a light-emitting element comprising a polarizing element, and the polarizing element configured to polarize at least portion of a light emitting from the light-emitting element;
wherein a polarizing direction of the polarizing element of the light-emitting element is different from a polarizing direction of the polarizing element of the camera module.

17. A light-emitting receiving system, comprising:
the camera module of claim 1; and
a light-emitting element comprising a polarizing element, the polarizing element configured to polarize at least portion of a light emitting from the light-emitting element, and the camera module receiving the light from the light-emitting element;
wherein a polarizing direction of the polarizing element of the light-emitting element is different from a polarizing direction of the polarizing element of the camera module.

18. A light-emitting receiving system, comprising:
a light-emitting element, comprising:
a polarizing element configured to polarize at least portion of a light emitting from the light-emitting element; and
a camera module configured to receive the light from the light-emitting element, and comprising:
an imaging lens assembly;
an image sensor disposed on an image surface of the imaging lens assembly;
a plate element farther from the image sensor than the imaging lens assembly from the image sensor on an optical axis; and
a polarizing element disposed on an image side of the plate element, so that an object-side light with a specific polarity from the plate element passing through;
wherein a polarizing direction of the polarizing element of the light-emitting element is different from a polarizing direction of the polarizing element of the camera module.
